(19) United States
(12) Patent Application Publication
(10) Pub. No.: US 2005/0108886 A1
(43) Pub. Date: May 26, 2005

(54) Apparatus for setting up articles for machining angles

(76) Inventor: Robert Trefry, Stamford, CT (US)

Correspondence Address: KARIN A. RUSSO, 49 GREAT OAK LN, REDDING, CT, 06896, US

(21) Appl. No.: 10/720,294

(22) Filed: Nov. 24, 2003

(51) Int. Cl. G01B 3/30

(52) U.S. Cl. 33/567

(57) ABSTRACT

An article machining apparatus is disclosed for use with a machine vise. The apparatus includes an article holding fixture with a securing section having a connecting bridge, foot and attached locator gauge pins. The fixture is oriented in the vise at a desired predetermined angle using three point contact of the fixture within the vise according to the dimensions stipulated in a MSN Excel program that provides variable data when fixed data such as the angle of machining the article is enclosed in addition to the diameters of the gauge pins and parameter dimensions of the fixture.

### FIELD OF THE INVENTION

The invention disclosed herein relates generally to the machining of parts, articles and components that require machined angular surfaces not otherwise machined or manufactured with those items, and more particularly, to the apparatus utilized to accomplish the required machining that is adaptable to standard manufactured machine vises and will accommodate planar machining tasks as well as angular machining with the same fixture.

### BACKGROUND OF THE INVENTION

When using heavy industrial equipment for machining parts, or for machining surfaces on the parts, the parts must be firmly and accurately secured. Securing the parts for such angular surface machining is accomplished through the use of standard manufactured vise assemblies that adapt to heavy industrial equipment such as a Bridgeport milling machine. The machining of surfaces on certain parts, components or structural elements can be difficult if those parts are very large, very long and otherwise awkward to secure, position, or manipulate in machining operations using the machine vises. Parts, components, or structural elements that are square, rectangular, round and otherwise shaped in cross section may be easily held in the vise jaw assemblies used in such heavy machining equipment as described above providing that there is no angular machined surfaces required in the operation. Since the vise jaws typically provided with vise assembly's move, are positioned rectilinearly and are arranged to readily adapt and clamp such parts between the jaws of the vise, it is usually a simple task to accommodate non-angular machining.

The difficulty and complexity of machining angular surfaces of such parts as described above has been addressed in the past by prior art involving the use of sine plates (for example), which are positioned to achieve a desired angle and resulting machined surface on a part, component or structural element once set up and fixed in the vise assembly. The set up of sine plates, the required procedure and accompanying information is described in various editions of Machinery's handbook as one example, and in some prior art that shows early patents of such e plates used for the purpose described above.

While the use of sine plates and similar equipment are used as described above, it has been discovered that it is desirable to have a more versatile set-up arrangement to facilitate a faster procedure to do so. This, along with the need for a tool and fixtures that quickly adapt to a machine vise to facilitate the machining of parts that are long, and otherwise difficult to clamp and hold in a pre-determined angular position in a machine vise will aid the machinists tasks. It is desirable from the machinist's point of view, to have an apparatus that facilitates rapid set-up and clamping of the article to be machined in a standard vise unit used in conjunction with such equipment like a Bridgeport milling machine. The set-up apparatus, as conceived, will have a simple designed fixture to be used in combination with a clamping device that readily adapts to the fixture in order to clamp and secure the fixture for adapting to the part, component or structural element to be machined. The set-up apparatus, therefore, is the apparatus that is used to mount an article that is to be machined, onto a mounting surface and adjustably clamping the apparatus, or the fixture, in the angular position desired to the machine vise assembly between the vise jaws. The inventive fixture is utilized with a combination of selectable gauge members from a set of such gauges. There is a simple table or mathematical formula that provides the settings that the operator must use to correctly set the fixture. The fixture is then set at a pre-determined, optimum desired angle for positioning the object in order to machine the part. Initial set-up of the apparatus and fixtures of the present invention is utilized in a set-up initiated from two or more basic angular starting fixtures positioned at 0 and 45 degrees. The fixture may be incrementally adjusted to sub angular positions by following a table and installing common spacer components as directed.

Another desirable feature is to use the fixture, as described above, for basic planar operations where no angular set up is required. The present invention accomplishes this since the fixture described herein will rest on the planar surfaces of spacer blocks located within the confines of the machine vise, and the vise jaws will clamp the fixture in place while the work piece is clamped to the upper portion of the fixture. The present invention accomplishes the above by providing such an apparatus through application of a fixture, accompanying spacer members, and a table or mathematical formula used to select a gauge in order to facilitate the desired pre-determined angular set-up in a machine vise. Finally, the present invention will be seen as a way to machine angles in articles by setting accommodating holding fixtures in a machine vice. Then, using supplied software and a computer, a calculated vise opening dimension is determined that accommodates three point contact of the holding fixture to create the desired angle to machine an article. The fixture is clamped within the vice to the desired set-up, thus enabling the machining operation.

### SUMMARY OF THE INVENTION

The present invention provides an article machining apparatus adapted for use with a machine vise having a pair of vice jaws with hardened article engagement surfaces. The apparatus includes an article holding fixture having an upper article securing surface or section connected to a bridge at an upper end and a foot section at a lower end. The foot section has an attached group of gauge pins arranged in a pattern wherein a first gauge pin contacts a first spacer block of a predetermined collection of spacer blocks, a second gauge pin contacts a first expandable vice jaw and at least a third gauge pin that contacts a vertical surface of the second vice jaw and a third spacer block that contacts the second vice jaw while supporting the third gauge pin. This arrangement is according to a predetermined and desired angular position of the article holding fixture. A fourth gauge pin is interfaced between the first spacer block and at least the third spacer block so that a horizontal surface of the first spacer block determines a vertical position of the first and second gauge pins while the pair of vise jaws clamp the article holding fixture between the second and third gauge pins. This arrangement satisfies the requirements of orienting the article holding fixture at a desired angle for machining an article secured to the upper article securing surface of the article holding fixture.

With the foregoing in mind, it will be appreciated that the instant inventor has developed an invention that may be used to quickly set up an article that is short, long, or has requirements for machining angles disposed in planes that oppose rectilinear surfaces. The invention provides for a rapid set-up of the article holding fixture in an accommodating vise assembly that may be set-up on the machinist's bench, or in the vise that is secured to the machining equipment. The article holding fixture is designed so that two alternate versions are available, one for machining articles requiring surface or sections requiring machine operations anywhere from a 0 to 45 degree angle, or a 45 to 90 degree angle with respect to ground. The parts, components and an input program designed for use in a computer is used to facilitate the set-up of several article holding fixtures in different situations to be held in a machine vise.

### DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 is a side elevation view of a 45-degree set-up of the article holding fixture of the present invention to be utilized in combination with the machine vise fixture of FIG. 2 as this combination may be utilized in a Milling machine for machining articles requiring a specific angular machining operation from 0 to 45 degrees;

FIG. 1a is a view taken along the lines of FIG. 1 with an alternate set-up arrangement of the article holding fixture;

FIG. 2 is a general isometric view of a typical machine vise fixture such as that shown in FIG. 1 for holding parts or components to be machined;

FIG. 3 is a general isometric view of a typical Bridgeport Milling machine showing a machine vise fixture positioned on the machining table, where the present invention may be utilized;

FIG. 4 is a side elevation view of a 90-degree set-up of the article holding fixture of the present invention to be utilized in combination with the machine vise fixture of FIG. 2 as this combination may be utilized in the Milling machine illustrated in FIG. 3;

FIG. 5 is a side-elevation view of the article holding fixture of FIG. 1 of the present invention to be utilized in a horizontal, 0-degree position in combination with the machine vise fixture of FIG. 2 as this combination may be utilized in the milling machine illustrated in FIG. 3;

FIG. 6 is an end view of the article holding fixture as seen in FIG. 1;

FIG. 6a is a left-side view of the article holding fixture of FIG. 6 as seen in FIG. 1;

FIG. 6b is a top view of the article holding fixture of FIG. 6;

FIG. 7 is an end view of the article holding fixture of FIG. 4;

FIG. 7a is a left-side view of the article holding fixture of FIG. 7;

FIG. 7b is a top view of the article holding fixture of FIG. 7;

FIG. 8 is a two-view representation of a typical narrow spacer block;

FIG. 8a is a two-view representation of a typical wide spacer block;

FIG. 9 is an enlarged geometric view of the bottom end of the article holding fixture, inclined at an angle;

FIG. 9a is an enlarged view of the bottom end of the article holding fixture as taken from FIG. 9;

FIG. 9b is an enlarged view of the first gauge pin of FIG. 9a;

FIG. 9c is a slightly enlarged view of the third gauge pin of FIG. 9a;

FIG. 10 is a computer having a keyboard for manual entry of data relating to the article holding fixture;

FIG. 11 is a table representing the program inputs, outputs and related calculation results for the set-up of the article holding fixture;

FIG. 12 is a table illustrating the mathematical formulas utilized by the MSN Trademark Excel™ program of the present invention showing fixed data and variable calculated data are to be printed from execution of the program;

FIG. 13a is a table representing the outputs based on the inputs for the angles in the range of 0-degree angle to 16.5-degrees;

FIG. 13b is a table representing the outputs for the angles in the range of 17.0-degree angle to 35.0 degrees; and,

FIG. 13c is a table representing the outputs for the angles in the range of 35.0-degree angle to 45.0-degrees.

FIG. 14 is a view taken along the lines of FIG. 4, illustrating the use of a cone piece setting block as an alternative to calculating basic angles.

### DETAILED DESCRIPTION OF THE PRESENT INVENTION

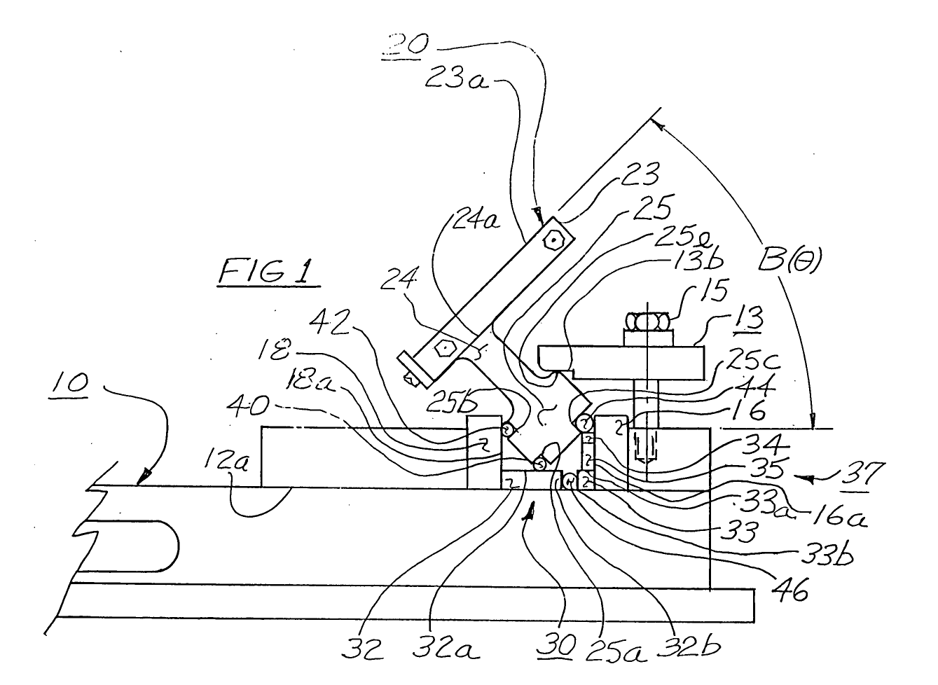

In describing the present invention, reference is made to the drawings, wherein there is seen in FIG. 1 a side elevation view of a commercial machine vise 10 and associated components of the present invention to be described. In FIG. 1, an article (not shown) would be clamped or otherwise fastened to the fixture of the present invention as will be explained in the following text.

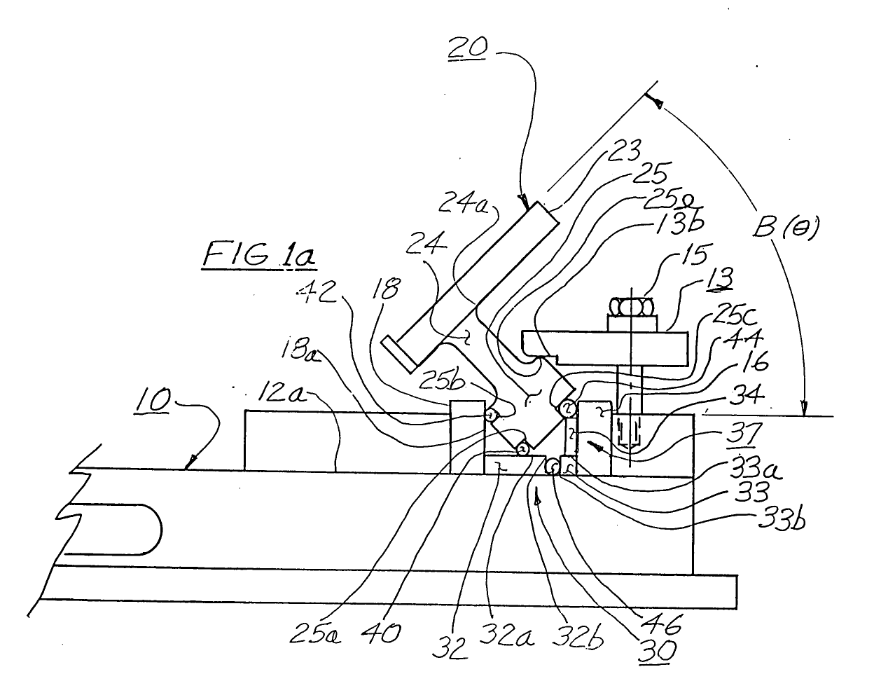

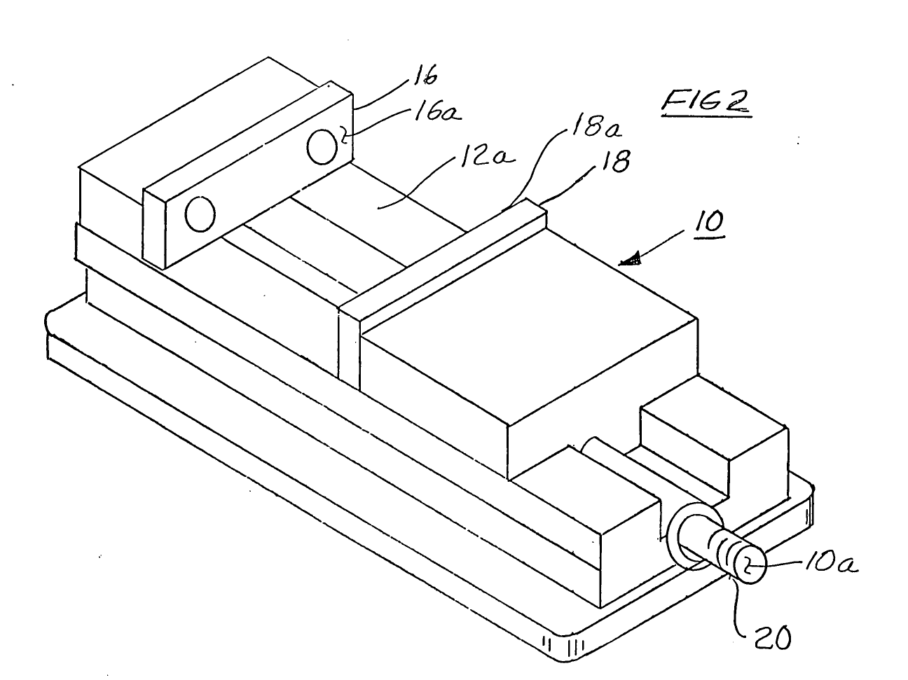

Referring to FIG. 2, there is shown a general, enlarged isometric view of the commercial machine vise 10 without the associated components of the present invention. FIG. 3 shows a general isometric view of a typical Bridgeport Milling machine 13. A machine vise 10 is illustrated as it is located on a Bridgeport machining table 14.

Referring again to FIG. 2, the machine vise 10 has a fixed vise jaw 16, and an adjustable, moveable or expandable jaw 18 that is normally adjusted to 30 clamp an article (not shown) in order for the article to be machined. An attached screw 10a is normally fitted with a handle (not shown) and is mounted in the vise 10 with associated bearings. A handle is utilized to hand crank the expandable vise to optimally position the expandable vise jaw 18 for holding an article holding fixture 20, or if angular machining is not required, the vise 10 may hold an article to be machined as is a normal practice. Supports of the machine vise 10 (shown but not described in detail herein) are typical of such a machine vise 10 as is well known in the industry. The machine vise 10 is fitted with the fixed vise jaw 16 and the expandable vise jaw 18, which are expandable and have a hardened article engagement surface 16a, 18a located on each respective jaw.

Referring to FIG. 1, the elevation view of the machine vise 10 is shown with the article holding fixture 20 positioned according to a set-up to receive an article (not shown for machining. In this example, the article holding fixture 20 is positioned at a 45-degree angle “B” for mounting the article; this set-up an illustration of one angle B that may range from 45 degrees to 1 degree or 0 degrees (near or at the horizontal with respect to ground) with alternate set-up components specified from the mathematical Excel program 60 (to be explained later).

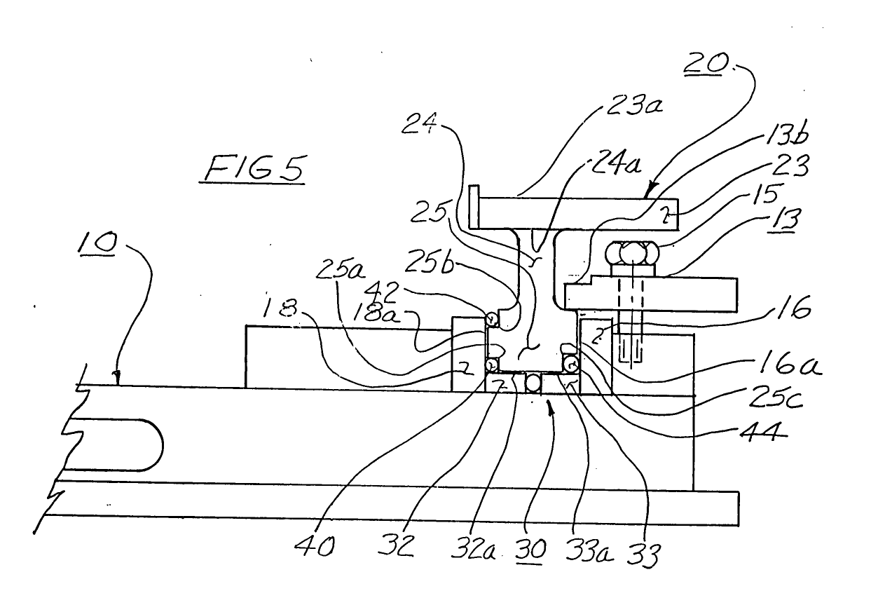

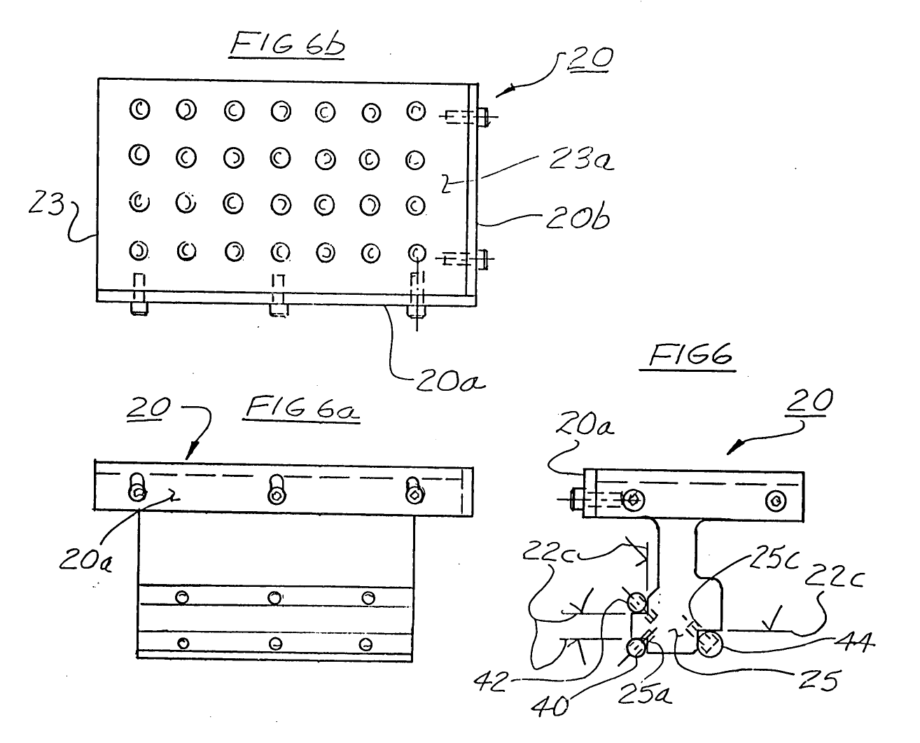

The article (not shown) to be machined would be mounted upon an upper article securing section 23 (or holding section) of the article holding fixture 20, and would be securely fastened on article securing section 23 by conventional means such as screws and bolts that fasten to the upper article securing section 23 via typical threaded apertures provided therein (FIG. 6b to be described later) in order to machine or otherwise fabricate the article or part at such an angle. Appropriate mechanical tooling hardware well known to those skilled in the art is utilized for clamping or otherwise fastening an article to such a securing section.

The machine vise 10 need not be positioned initially on the Bridgeport machining table 14 (FIG. 3) while a set-up is being calculated by the program 60. The machinist's bench may be utilized to position the article holding fixture 20 in the vise 10 for any machining operation and any set-up components such as spacer blocks or gauge pins applied there.

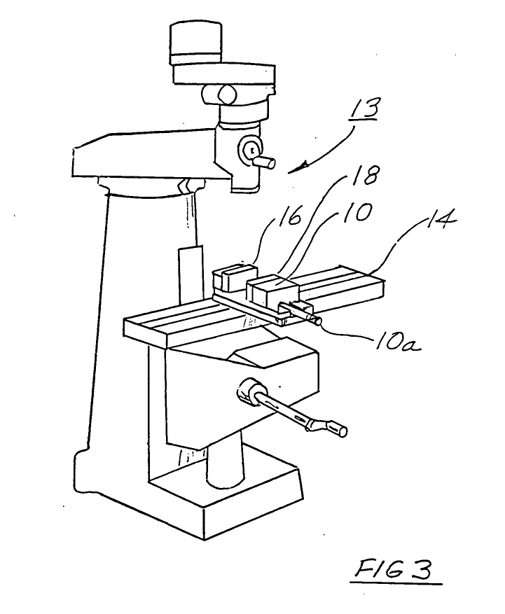

There is a basic set-up for the article holding fixture at angles of 0-degrees, 45-degrees and 90-degrees (FIG. 4) for an article machining process involving those angles, or for an incremental angle in between. The article holding fixture 20 and alternate fixtures to be described is intended to be used for machining extraordinarily long articles or those components of any length requiring angular milled surfaces that are otherwise difficult to obtain by a milling operation. The article holding fixture 20 provides stability for machining any shaped article or piece that is short or long in length. The instant inventor has experienced that machining the types of parts, i.e., articles and components described above that require such angular milling, is difficult, if not impossible without the use of the present invention. It is difficult to position and machine articles with commercially available fixtures and associated devices when close tolerances are required especially when the milling or machining operation is being done on long surfaces of long or complicated-shaped parts.

As described in the foregoing text, the set-up of the machine vise 10 is illustrated in FIG. 1 as it would apply to machining a part requiring a 45-degree surface milling operation. The article holding fixture 20 is positioned at the required angle for surface milling of an attached article or part (not shown). The fixed vise jaw 16 and the expandable vise jaw 18 are shown in the clamped arrangement for holding the article holding fixture 20, as will be described in more detail.

Within FIG. 1, 1a there is a clamp member 13 illustrated with a clamping surface 13b which engages a lower foot section 25 at a point 25e. The member 13 is held in place by a suitable collection of bolts 15 that are tightened against appropriate threaded holes in the vise 10. (It will be understood that there is at least two such bolts in collection 15 that appropriately are spaced apart laterally on the member 13, or there are more than one member 13).

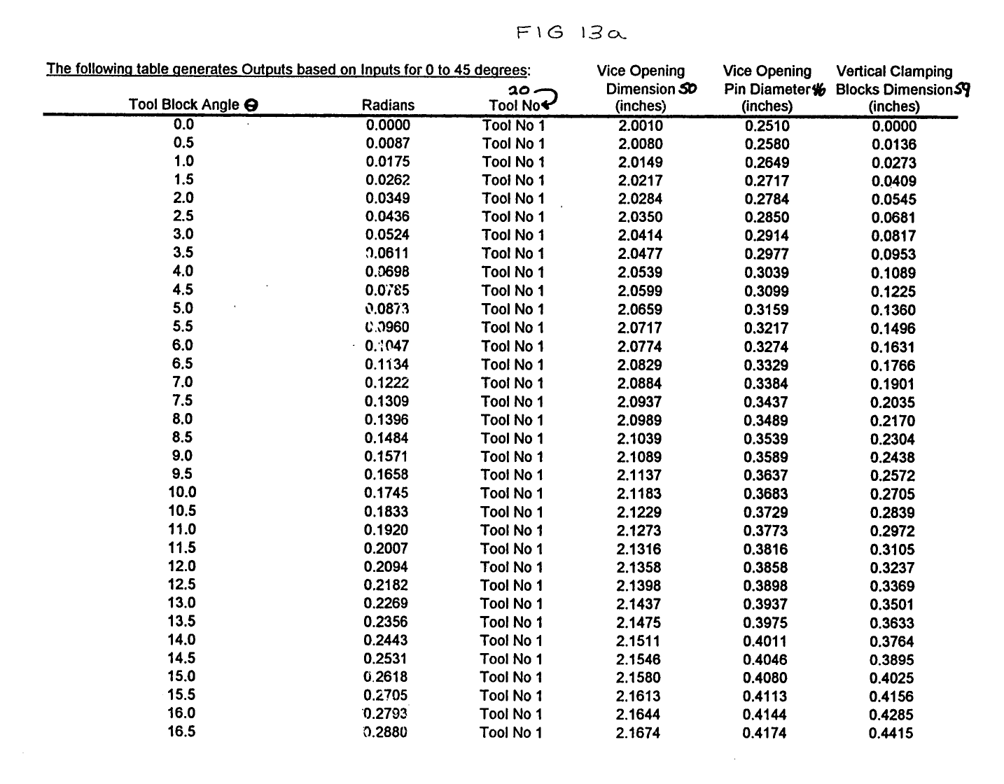

It is a standard machinists practice to use spacer blocks (otherwise known as clamping blocks or gauge blocks) and gauge pins for gaining exact dimensions and measurements for machining or set-up of parts for inspection of those parts. The combinations of spacer blocks (otherwise known as gauge blocks) and gauge pins augment the present invention in a way such that their use is predictable as applied by reference to a set-up table (FIG. 12 to be described later) and output of a mathematical program.

The vise jaws 16 and 18 are typical in that they have hardened article engagement surfaces, 16a and 18a, respectively, that assure there will not be any change in the surface texture of the machine vise jaw surface due to clamping the fixture 20 between the vise jaws 16, 18. This is typical in the construction of such machine vise fixtures since accurate positioning of the articles being machined is important when the final machined surfaces of the work piece are milled, cut or otherwise obtained by the machining process being utilized.

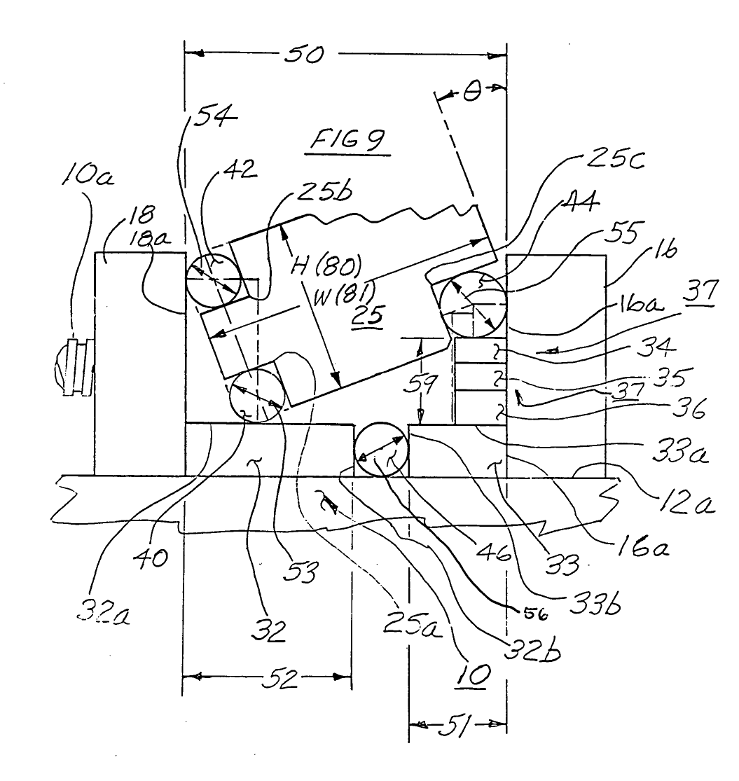

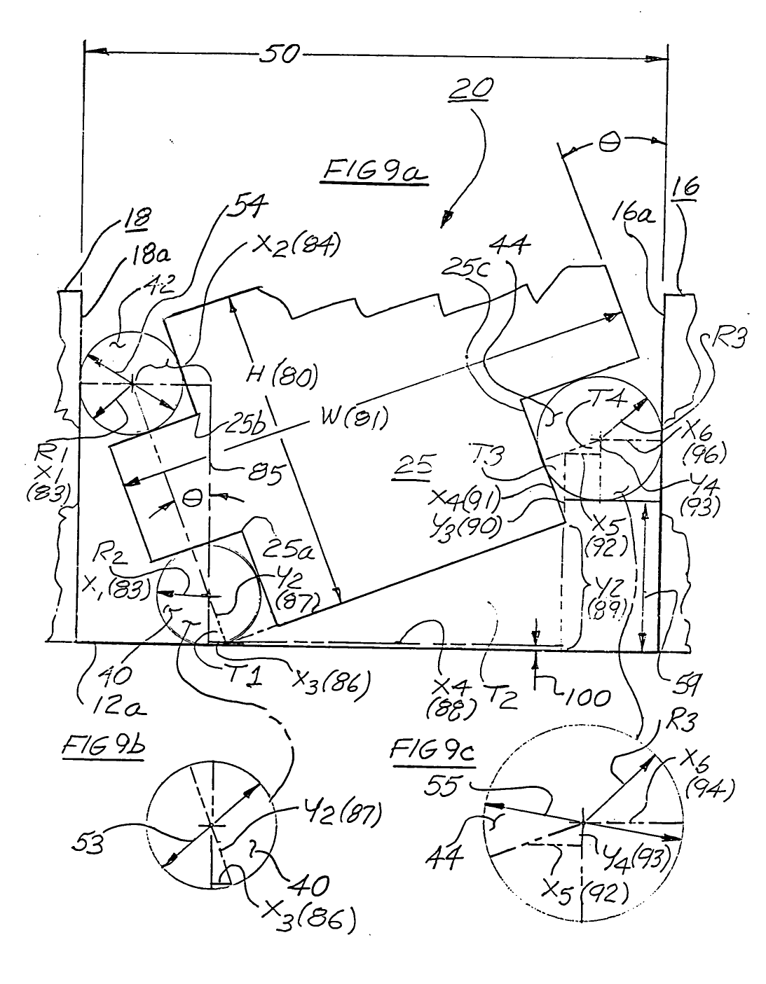

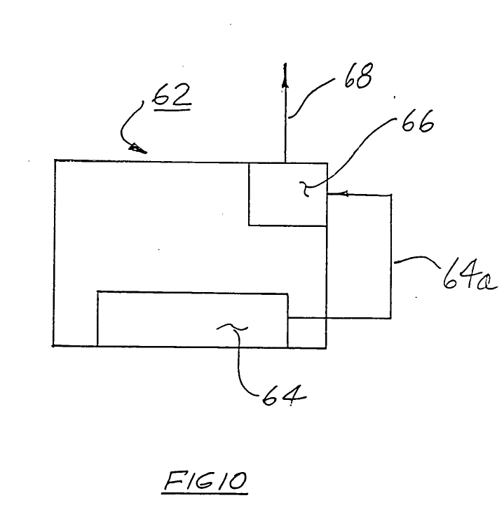

There is a plurality of selected spacer blocks 30 otherwise designated as a group of spacer blocks having fixed dimensions, (the width and height of which are derived from the program 60), and at least one gauge pin (to be described later) located and positioned between the two of the group of spacer blocks 30. The two spacer blocks will-be positioned between the fixed vise jaw 16 is and the expandable vise jaw 18 providing the program 60 calls for them. At least two of the spacer blocks 30 are clamped between the vise jaws 16 and 18 of the machine vise 10 in a horizontal orientation while being positioned on a floor surface 12a of the vice 10 with a gauge pin 46 interfaced between them. This arrangement is to define a predetermined overall vice opening 50 dimension (FIG. 9) in an area located between the fixed vise jaw 16 and expandable vise jaw 18 and beneath the lower foot section 25 of the article holding fixture 20.

The spacer blocks 30 are typical commercially available components and are hardened as is typical with typical tooling devices such as gauge members, clamp spacers, or gauge blocks or spacer blocks that are 0.250 or 0.500 inches thick. (Refer to FIGS. 8, 8a for additional detail)

Referring again to FIG. 1, resting upon a top surface 32a of a first spacer block 32, is a first gauge pin 40 that is located within a machined recess 25a of the lower foot section 25 of the article holding fixture 20 within the vise 10. The first gauge pin 40 provides a first locating point for a planar vertical positioning of the article holding fixture 20. A second gauge pin 42 of the same diameter as the gauge pin 40 is located in a second machined recess 25b of the article holding fixture 20 and associated lower foot section 25.

Gauge pin 42 provides a horizontal locating point of contact for the article holding fixture 20 when it is registered against the vice jaw 18. The gauge pins 40, 42 are optimally 0.375 inches in diameter and considered a fixed part of the input of the program 60. The size of the pins 40, 42 may be different if included in the calculations and formulas of the program 60 in another version that would produce different characteristics of the spacer blocks in dimensions. Therefore, it will be recognized by those skilled in the art that alternate sizes of gauge pins may be substituted into the program 60 for locating the fixture 20 within the vise 10. For the present description, the gauge pins 40, 42 are used having the 0.375-inch dimensions. The second gauge pin 42 contacts, and is located by, the hardened article engagement surface 18a of expandable vise jaw 18 when the jaws 16, 18 are clamped shut and the first gauge pin 40 is registered vertically against the spacer block 32. A third gauge pin 44 having a 0.500 inch diameter provides a third locating point to position and locate the article holding fixture 20 at the desired angular position thereby achieving the desired angle “B” (45 degrees in the present case). The gauge pin 44 also is a fixed value of 0.500 inches that will be entered into the program 60.

In FIG. 1, a spacer block 34 rests upon a spacer block 35 which in turn rests upon another spacer block 35, and yet another spacer block 36, all of which may be described as a vertical stack of spacer blocks 37 that are provided based on the output of the program 60 to be described later to make up a dimension height 59 for the set-up of the fixture 20. The third gauge pin 44 contacts a top surface 34a of spacer block 34 and also contacts the hardened article engagement surface 16a of the fixed vise jaw 16. The vertical stack of spacer blocks 37 comprises one or more spacer blocks that provide the required height 59 of the position of the third gauge pin 44, thereby providing one element of the angular positioning criteria of the fixture 20. The spacer blocks 32 and 33 rest upon the surface 12a of the vise assembly 12. The lower foot section 25 of the fixture 20 can be generally square-shaped, generally rectangular shaped or whatever shape provides the necessary clearance and assembly of the gauge pins 40, 42, and 44 to the fixture 20 and to associated gauge blocks used in conjunction with a set-up such as that being described.

The third gauge pin 44 has a diameter that is not equal to the diameter of the gauge pins 40 and 42, and is secured to the foot 25 in a recess 25c of the fixture 20. The gauge pins 40, 42 and 44 may be fastened by suitable hardware to the foot 25 of fixture 20, or may be magnetized to adhere to the locating notches (to be described later) of the fixture 20.

Alternatively FIG. 1a shows article holding fixture 20 adapted for use with the machine vise 10 in an arrangement to achieve the angle “B” where the first gauge pin 40 is positioned on the first spacer block 32, the second gauge pin 42 is positioned against the hardened article engagement surface 18a of the expandable vise jaw 18 and the third gauge pin 44 is positioned against the hardened article engagement surface 16a of the fixed vise jaw 16.

The article holding fixture 20 has an upper article securing section 23 connected to a bridge 24 at a bridge upper end 24a. The foot section 25 is connected to the bridge 24 at a bridge lower end 24b. It will now be seen that the foot section 25 with the attached group of gauge pins 40, 42, and 44 are arranged in a triangular pattern as they are fastened or located on the foot 25 of the fixture 20 as shown in FIG. 1, 1a etc. Described above, with reference to FIGS. 1, 1a, 4, 5 the first gauge pin 40 contacts the first spacer block 32 of the group of spacer blocks 30. The second gauge pin 42 contacts the hardened article engagement surface 18a of the expandable vice jaw 18. The third gauge pin 44 contacts the vertical hardened article engagement surface 16a, according to a predetermined angular position (angle “B”) desired by the machinist for the article holding fixture 20. In addition, the gauge pin 44 sits on top of a spacer block 34, which is part of the group of spacer blocks 30. The spacer block 34 may be replaced by a stack of spacer blocks 37 providing the dimension height 59 is met by a combination of gauge block thicknesses. There is a second spacer block 33 of the predetermined collection of spacer blocks 30 that contacts the fixed vice jaw 16. A fourth gauge pin 46 is interfaced between the first spacer block 32 and the second spacer block 33. The fourth gauge pin 46 contacts a vertical surface 32b of the first spacer block 32 and a vertical surface 33b of the second spacer block 33 of the predetermined group of spacer blocks 30 while the vise jaws 16, 18 clamp the article holding fixture 20 through engagement with the gauge pins 42, 44. This arrangement thereby satisfies a plan of orienting the article holding fixture 20 at the desired angle “B” in FIG. 1, 1a, for machining an article secured to the upper article securing section 23 of the article holding fixture 20. There is less spacer blocks illustrated in FIG. 1 a since this is an alternative embodiment that may be possible depending on the output calculations of the program 60. FIG. 1a illustrates a specific angular set-up capability requiring fewer components such as the spacer blocks of the group of spacer blocks 30.

Dimensions and components needed to machine an article; at a predetermined angle secured to an article holding fixture 20 in FIGS. 1 and 1a are calculated from the mathematical program 60 derived from a MSN Excel™ application 66 which is suited for manual entry of a collection of data into a set of formulas.

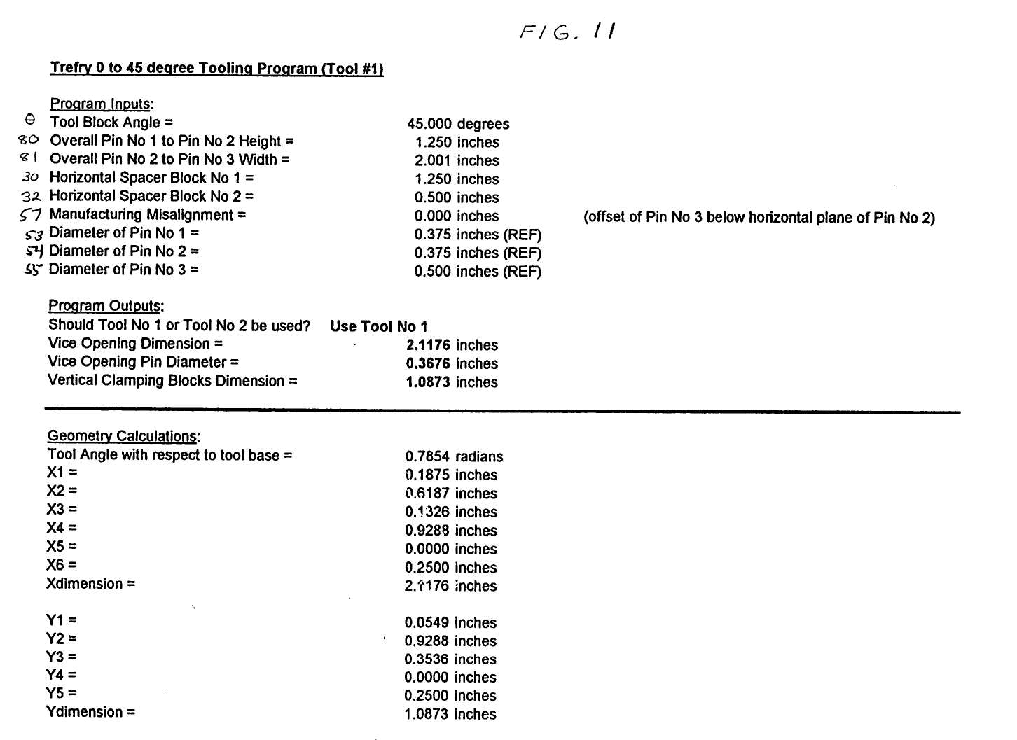

In FIG. 10, there is seen a computer 62 having a keyboard 64 for manual entry of data relating to the article holding fixture angular position to be determined. A path 64a within the computer will be understood to convey keyboard instructions to the application 66. There is an output 68 from the application 66 and associated program 60 that provides calculated data in a table form that may be printed as seen in FIG. 12, and 13. First, the angular position of the article holding fixture 20 is determined (example angle “B”) as desired by a predetermined machining operation to be performed on an article (not shown). The data is entered into the mathematical program 60 as input data in fixed values including the diameters of the gauge pins 40, 42 & 44 along with the angle “B” definition (45 degrees in this case). The data is processed according to the formulas shown in accompanying FIG. 12 to obtain a dimensional result of components such as the spacer blocks 30 and the gauge pin 46. The diameters and radii of the gauge pins 40, 42 and 44 are entered as fixed values already known. The actual dimensions of the spacer blocks 30, 32, 33 or stack of spacer blocks 37 are defined later in the specification as calculated data or outputs from the program 60 as run through the application 66. Depending upon the results of the program 60, the need for a given number of spacer blocks such as those described in FIG. 1 or FIG. 1a may, or may not, be required. This is dependent upon the initial angle of machining desired and the calculated results of the program 60.

The machinist will follow the output instructions of the calculations generated by the program 60 and place the required components (spacer blocks 30, and gauge pin 46 of FIG. 1) in place for the set-up. The spacer blocks 30 are shown in FIG. 1a, but, those skilled in the art will recognize that the bottom floor of the machine vise may suffice as a locating surface for the first gauge pin 40 in that particular set-up if there was a vice opening dimension calculated from the program 60 that fit that arrangement, and the clamping force exerted through the gauge pin 42, fixture foot 25 and gauge pin 44 were aligned at the position shown in FIG. 1a at “B” degrees (45 degrees). Those skilled in the art may also recognize that the angular position “B” of the set-up of FIG. 1a may be specifically 45 degrees or slightly less to ensure that the fixture 20 will stay in place. There will be a clamping force exerted through the gauge pins 42, the fixture foot 25, and the gauge pin 44 that will keep the fixture 20 in place for angles ranging in the order of 45 to 0 degrees. Angles not in that range (for example −1 degree or 359 degrees) would not be satisfactory, nor would angles that are more than 45 degrees for the use of fixture 20 with the arrangement shown in FIG. 1, 1a.

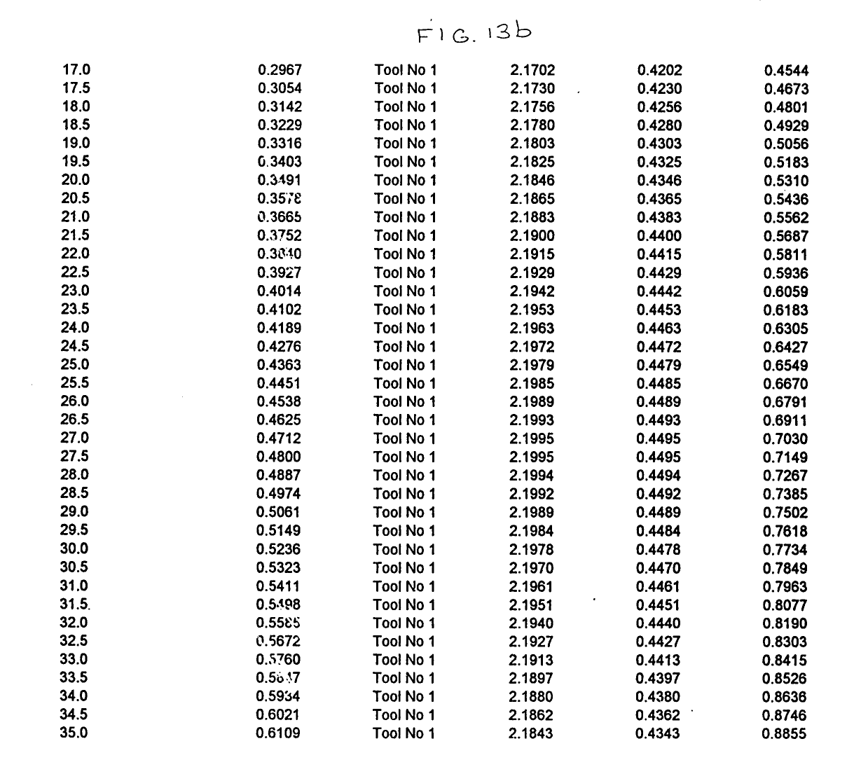

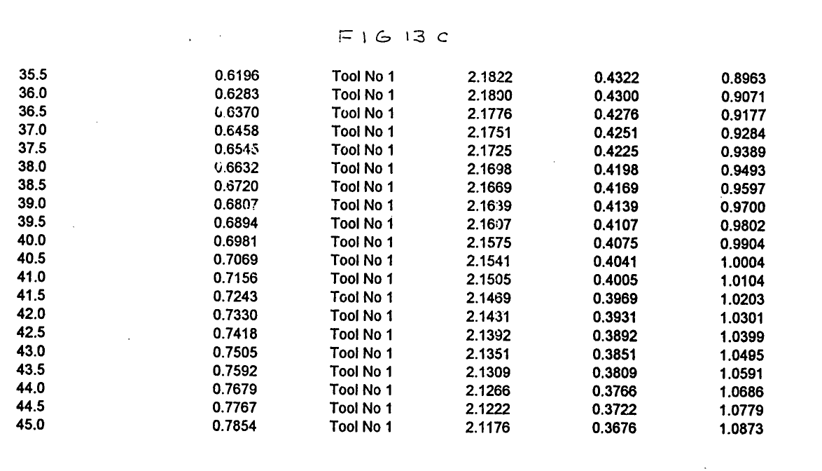

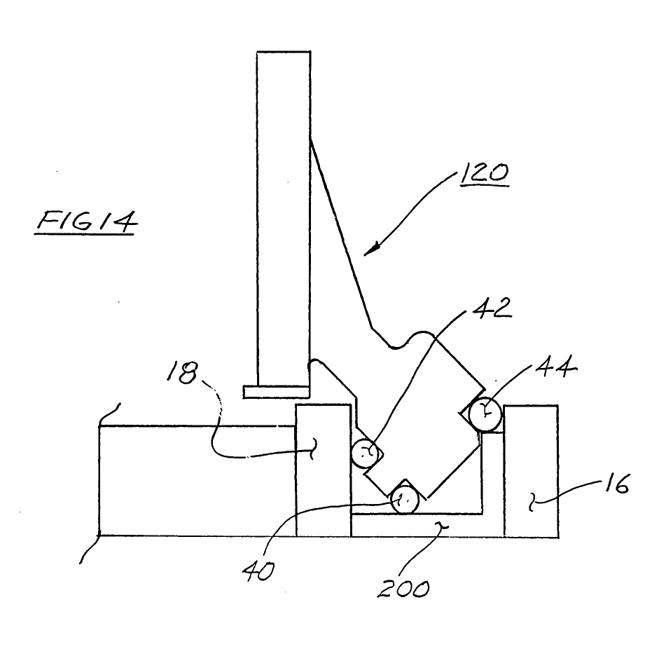

A reference table FIG. 13a, 13b, 13c is used to select the predetermined angular position of the article holding fixture 20 and the required dimensions that will meet the set-up of the fixture 20 in the set-up arrangements defined above for FIG. 1 and 1a.

Within the description of the program 60, the fixed value of representing the first gauge pin 40 with diameter 53, second gauge pin 42 with diameter 54, the third gauge pin 44 with diameter 55 are entered. A dimension 52 (FIG. 9) of the spacer block 32 is calculated via program 60 in order to obtain the space between the vice jaws 16, 18, to meet the requirements of the desired fixture 20 position. The program 60 will also calculate a dimension 51 (FIG. 9) for the spacer block 33 and as such will be read from a printed table to be illustrated in FIG. 13.

It will be recognized that there is a need to achieve angles from the range of 0-degrees to 45-degrees and alternately between 45-degrees to 90-degrees with respect to machining requirements on articles. Therefore, an article holding fixture 120 in FIG. 4 would replace the article holding fixture 20, and will be utilized with the same arrangements of gauge pins but with calculated dimensions for other spacer blocks as determined from entering other angle positions desired into the program 60. This new set-up and fixture 120 position provides steeper angular machining angles as may be required from 45 degrees to as much as 90 degrees as defined above. The fixture 120 has a foot section 125, a bridge 124, and would be accompanied by appropriate gauge pins 40, 42, 44, 46 similar to that described above with reference to the article holding fixture 20 where gauge pin 46 would be calculated in the program 60 mentioned above. There is a machined notch 125a for the pin 40, 125b for the pin 42, and a notch 125c for the gauge pin 44 which is similar to that seen in FIG. 1, 1a, 4, 5, 9.

The article holding fixture 120 in FIG. 4 is used to achieve machining on articles that require a steeper angle, (angle “C”) or angles at or approaching 90 degrees as shown in FIG. 4. It will be recognized that article holding fixture 20 and article holding fixture 120 are different because of the preset angle defined by the angle of the article mounting surface 23 and an article mounting surface 123a on each device respectively. Specifically, the article-mounting surface 23 on article holding fixture 20 is substantially parallel to the foot section 25. This contrasts with the article mounting surface 123a with respect to the foot section 125 on article holding fixture 120 which is oriented at a 45-degree angle, angle “C” with respect to the foot section 125. The article holding fixture 120 is generally tilted optimally 45-degrees to begin with before any mounting of an article to be secured to the holding surface 123a.

The machine vise jaw assembly 10 is shown holding the article holding assembly 120 in position (including angle “C”) for machining an article that would be attached to surface 123a. The spacer blocks 30 are shown once again as they are located between the jaws 18 and 16 of the vise jaw assembly 12. The set-up of the article holding fixture 120 with the spacer blocks 30 and the gauge pins 40, 42 & 44 is the same as that described for FIG. 1, 1a. Differences in the dimensions of the spacer blocks 30 may be evident once the calculations are generated from the program 60, using the new angle 90 degrees or whatever angle is desired that is less than 90 degrees. Variations in the desired angular position between 45 degrees and 90 degrees is achieved by replacing the spacer blocks in the stack 37 in the appropriate pre-determined arrangement of gauge blocks to be selected from the chart (FIG. 13a, 13b, 13c) as determined by the program 60 to be described.

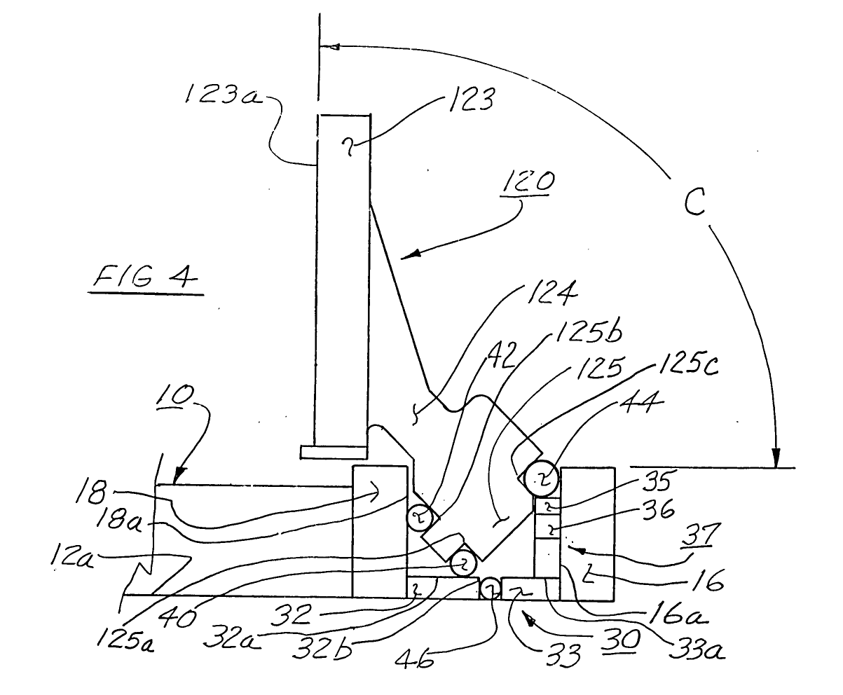

Referring to FIG. 5, there is shown an article holding fixture 20 positioned to machine articles that do not need to be positioned with an angle greater than horizontal, 0-degrees, but rather to hold the articles in the horizontal position shown. The article holding fixture 20 is positioned with the article mounting surface 23a parallel to the vise assembly floor 12a. Spacer blocks 32 and 33 are shown with the fourth gauge pin 46 interfaced between them to extend as far as the widest part of the foot section 25 positioned between the fixed vise jaw 16 and the expandable vise jaw 18. Alternately, any combination of spacer blocks without a gauge pin interfaced between the spacer blocks would provide the necessary height for the clamping member 13 to hold the fixture 20 in place while holding the fixture 20 in the desired position. Additionally, one long spacer block (not shown) that extends the width of the necessary vice jaw opening would be possible. Gauge pins 40, 42, 44, provide support at each of the corners of the foot section 25 of the article holding fixture 20 as the clamping member 13 presses on the top 25d of foot section 25. It will be noted that clamping member 13 is inverted in FIG. 5 when the article holding fixture 20 is positioned for a 0-degree angle machining process. The flat section 13b of the clamping member 13 presses against the top of foot section 25d. It also will be apparent that an angle of 1 degree or more would require a change in spacer block height in respect to the block 33, or that blocks would be added above block 33 as required by the program 60. With reference to FIG. 4, the member 13 is not shown but will be understood to be implemented in a similar manner to that just described.

The article holding fixture 20, 120 illustrated in FIG. 1, 1a, 4 and 5 is formed as a steel casting, but may be formed of steel plates as will be evident by those skilled in the art. With this in mind, and referring now to FIG. 6, 6a, 6b, and 7, 7a, 7b there is shown three basic views of the article holding fixture 20 with the right hand view being the same as is represented in all of the elevation views FIG. 1, 1a, 4 & 5 of the present invention description for the article holding fixture 20 and 120 respectively.

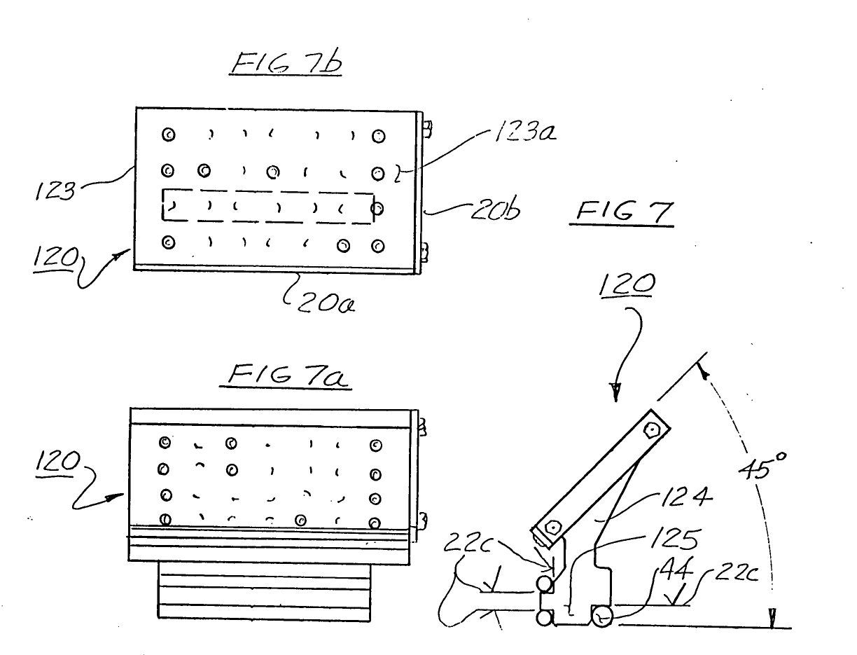

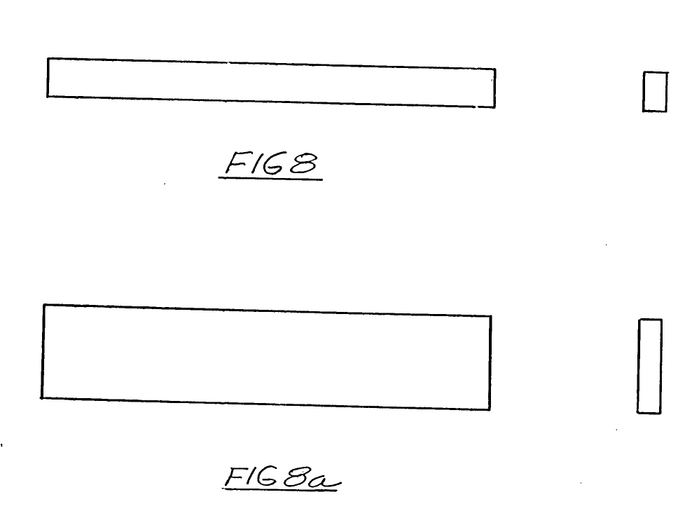

The article holding fixture 20 in FIG. 6, 6a, 6b and FIG. 7, 7a & 7b shows the basic construction of the article holding fixture 20 and 120 respectively. FIG. 6 will be recognized as it illustrates the fixture 20 as depicted in FIG. 1 and FIG. 1a for example. The fixture 20 is a typical steel casting having appropriate machined surfaces that will locate or hold the gauge pins described above or other locating components for articles to be machined. Some of the machined surfaces of the fixtures 20, 120 are illustrated with a check mark 22c with a purpose of locating the gauge pins 40, 42 and 44 in the resulting machined notches 25a , 25b & 25c with machined surfaces defined by the check marks 22c. All gauge pins, 40, 42, and 44 are appropriately secured to the lower foot section 25 of the fixture 20. (Or the gauge pins 40, 42, and 44 could be magnetized and fastened in that manner).

The FIG. 6a is a left hand view of the fixture 20, generally “T” shaped and having appropriate attachment apertures as would be used by those skilled in the art where the articles would be attached for example to the article mounting surface 23. There are also stop plates such as stop plate 20a, and 20b used to locate an article on the article mounting surface 23a prior to loading the fixture 20 into the machine vise 10. Some parts of the article holding fixture 20 are adjustable in order to position articles for machining as is well known and exercised by those skilled in the art. For example, there is a need for various stop plates to locate articles on the holding surface. This is typical in machining articles at a specific angle and position. The stop plates locate the articles for a particular arrangement or surface to be machined by the overhead cutting apparatus of the Bridgeport Milling equipment.

In a similar fashion, the fixture 120 is manufactured with a basic angular mounting surface 123a, as shown by the angle “C” (45 degrees) as seen in FIG. 7.

FIG. 6 illustrates a stop plate 20a which is utilized to locate and accommodate an article on either end of the mounting surface 23 as well as an end stop plate 20b that can be mounted on one or both sides of the article holding fixture 20 in the area of the mounting surface 23. Gauge pins 40, 42, & 44 used with the article holding fixture 20 or 120 are mechanically secured with appropriate machine screws to the article holding fixture 20 or 120. The components described for fixture 20 as shown in FIG. 6 may be applied to the fixture 120 in the same manner as they serve the same fastening and locating functions for article to be machined.

FIG. 8 illustrates some sample spacer blocks of 0.250 and 0.500 inches thickness that are commercially available for use with the fixtures 20 and 120, specifically, for the set up of those fixtures.

Referring to FIG. 9, an example of the article holding fixture 20 set-up resulting from reference to the chart, FIGS. 13a, 13b, and 13c, is now discussed. Reference to FIG. 9 and the associated detailed chart will provide an example of how to apply appropriate spacer blocks to a given set-up such as that described in reference to FIG. 13.

FIG. 9 shows the dimensional relationships for the components of the article holding fixture 20 with the stack of spacer blocks 37, spacer blocks 32, 33 and gauge pin 46. FIG. 9, 9a and 9b illustrate the article holding fixture 20 shown in FIG. 1a with enlarged features for easier identification and viewing. The relationships of the typical components are described in the following part of the instant specification. The first spacer block 32 is positioned adjacent the expandable vise jaw 18. The second spacer block 33 has the horizontal length 51 while the first spacer block 32 has the horizontal length 52, both derived from the program 60 as previously described. The first gauge pin 40 has a diameter 53. The second gauge pin 42 has a diameter 54. The third gauge pin 44 has a diameter 55. The fourth gauge pin 46 has a diameter 56. The summation of the lengths 52, 51 of the spacer blocks 32, 33 and the diameter 56 of the fourth gauge pin 46 will equal the vise opening 50 measurement that is calculated in the program 60.

Resting upon a surface 32a of spacer block 32 is gauge pin 40 (diameter 53). The second gauge pin 42 (diameter 54) contacts the hardened article engagement surface 18a of jaw 18. A first dimension H 80 between the gauge pin 40 and the gauge pin 42 is a fixed value, achieved at the manufacturing of the fixture 20 and 120. This dimension 80 is entered into the program 60. The third gauge pin 44 having diameter 55 rests upon a top surface 33a of the spacer block 33 of the stack of spacer blocks 37. Gauge pin 44 also engages the hardened surface 16a of the vice jaw 16.

FIG. 9, 9a, 9b represent the set-up of fixture 20, as well as a possible set-up of fixture 120 (the foot 25 is the same for both fixture 20 and 120) where alternate spacer blocks may be used to accommodate the desired predetermined angular set-up angle. The geometric aspects of the relationship of the gauge pins 40, 42 and 44 shown will now be described as they relate to an angle θ. Dimension H, 80, is an overall height over the diameter of gauge pins 40 and 42 as measured tangentially to the pins 40, 42. This is the height over the pins 40, 42 to their respective outside diameters 53, 54. Dimension w, 81 represents an overall width of the foot section 25, and is also tangential to the diameters of the gauge pins 40 and 44.

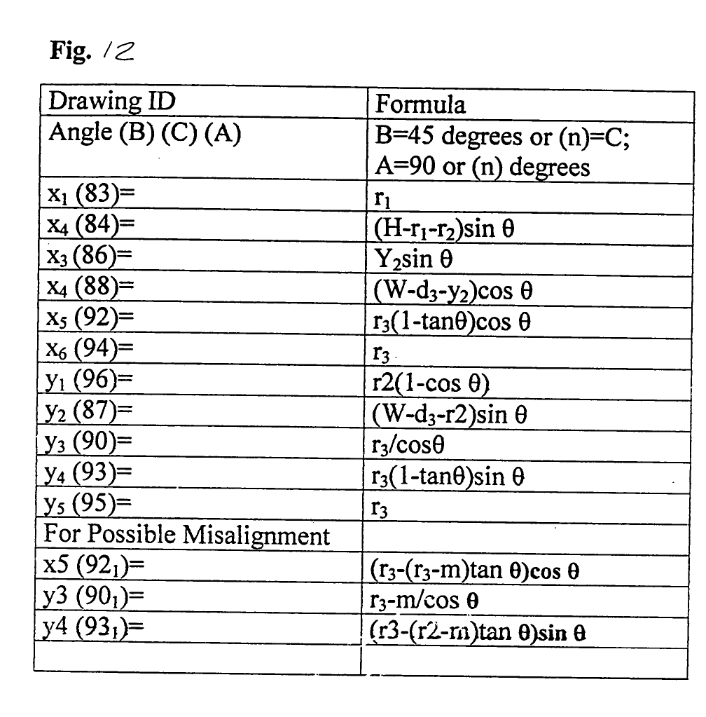

For this description, it will be found from the program 60 results in FIG. 11 and FIG. 12 that spacer block 30 is 1.250 inches wide as measured along the vise jaw assembly floor 12a and spacer block 32 is 0.500 inches as measured along floor 12a. Reference is made to FIG. 1, 1a, or 9 as to the relationship of the group of spacer blocks 30 to the gauge pin 40 and the fixture 20.

The angle θ is used to describe the following geometric relationships for FIG. 9, 9a, and it will be recognized that angle θ=Angle B for this description. The spacer block 30, 32 are not shown in FIG. 9a for reasons of clarity. A dimension x₁, 83, is the radius of the gauge pin 40 and gauge pin 42 as may be seen in the accompanying FIG. 12. Gauge pins 40, 42 are equal in diameter, as previously described. A dimension x₂, 84, is the distance from the center of gauge pin 42 to upper leg 85 of the relationship of the center of the pin 42 to the center of gauge pin 40. A dimension x₃, 86 is the short leg of a triangle T1 within the gauge pin 40, having a hypotenuse Y₂, 87 as determined by the pins 40, 42 radius 83.

Continuing, a dimension x₄, 88 is one leg of a relating horizontal triangle T2 having an upper leg Y₂, 89. Another relating triangle T3 has a hypotenuse Y₃, 90 and a leg x₄, 91. Another triangle T4 has a horizontal leg x₅, 92, and a vertical leg y₄, 93, having one apex located at the center of the gauge pin 44.

further, in the area of gauge pin 44, the dimension x₆, 94, will be recognized as the radius of the pin 44 also entered as a fixed value in the program 60. In this case, that radius is 0.250 inches, as the diameter of pin 44 is 0.500 inches. In this example, the radii r2, r1, and r3, of pin 40, 42 and 44, respectively, are 0.1875, 0.1875, and 0.250 inches.

Referring to the accompanying table in FIG. 12, it is seen that the various dimensions called out in the foregoing list are qualified as for example:
X1(83)=r₁=r₂
X2(84)=(H−r₁−r₂) sine and so forth.

The foregoing formulas and identified fixed and variable parameters described above and seen in FIG. 12 thereby describe all of the components for an Excel™ spread sheet that would be entered into the program 60 in order to produce the output dimensions defined in the table for machining an article using the tools of the present invention.

In FIG. 11, there is an example of the tooling inputs as it may be utilized within a common personal computer (PC) for a machine operator to refer to in machining articles such as those described in the prior text. Reference may be made to FIG. 9 where the article holding fixture 20, by way of example, is utilized. The fixture 20 is shown to be positioned at angle θ. In the example following, an article (not shown) is going to be machined on a surface that requires a 45-degree machining operation which would be the angle Φ in the example in FIG. 9, 9a. The cutting equipment is positioned above the article holding fixture 20, as will be recognized by those skilled in the art, and the components for achieving the initial set-up are defined as follows:

Referring now to the table in FIG. 11, is an example of data that would be inputted to the Microsoft Excel™ program:
The tool block angle A, B or C (or 0) equal to 45 degrees is entered.
The fixed diameters 53, 54, 55 of the gauge pins 40, 42 and 44, respectively, are entered. In this case, those are 0.375, 0.375 and 0.500 inches respectively.
The overall height H (80) of the first gauge pin 40 overall dimension to the second gauge pin 42 is entered which is 1.250 in this example.
The overall width W (S1) of the second gauge pin 42 to the third gauge pin 44, or 2.001 for this example, is entered.
The length 51 of the horizontal first spacer block 32 is calculated in the program 60.
The length 52 of the second horizontal spacer block 34 is calculated in the program 60.
The misalignment measurement 57 is entered if it appears in the program output as an incremental amount ranging up to 0.001 inches or less, which will be absorbed into the set-up and accounted for in the final tolerances of the machined article or part. If there is a minor difference in the geometric relationship of the set up shown in FIG. 9a, the misalignment measurement would occur as shown by dimension 100. This minor discrepancy would be integrated into the program and result in a minor deviation in the final desired angle θ.

The resulting dimensions defined by the vice opening 50 and the vertical clamping blocks dimension height 59 in FIG. 13 provides the machinist or operator with a total value to be met by assembling gauge blocks and associated gauge pins as defined herein. The information that would be outputted from the program is seen in the attached drawings of FIG. 13a, 13b, 13c.

One alternate embodiment of the foregoing arrangement is depicted in FIG. 14 wherein a one piece setting block 200 is utilized in place of the various gauge blocks, gauge pins and so forth previously described above. This arrangement is provided for machining repetitive jobs requiring basic set-up angles such as 45 degrees as shown in FIG. 14. The one piece setting block would also be provided in other basic profiles that would provide for example a 30 degree set-up, and so forth (not shown).

While the present invention has been disclosed and described with reference to a single embodiment thereof, it will be apparent, as noted above, that variations and modifications may be made therein. For example, it is possible to have two or more machine vise's set up in the previous described process in the event it is necessary to hold an extra long article in place for machining on the milling table. It is also noted that the present invention is independent of the machine being controlled, and is not limited to the control of inserting machines. It is, thus, intended in the following claims to cover each variation and modification that falls within the true spirit and scope of the present invention.

1. An article machining apparatus adapted for use with a machine vise having a pair of vice jaws with hardened article engagement surface article engagement surfaces, the apparatus comprising:
an article holding fixture having an upper article securing section connected to a bridge at an upper end and a foot section connected to the bridge at a lower end, the foot section having an attached group of gauge pins arranged in a pattern wherein a first gauge pin contacts a first spacer block of a predetermined collection of spacer blocks, a second gauge pin contacts a first expandable vice jaw and a third gauge pin contacts a vertical surface of a second vice jaw, accordingly; and,
a third spacer block of the predetermined collection of gauge blocks that contacts the second vise jaw while supporting the third gauge pin, and a fourth gauge pin interfaced between the first spacer block and a second spacer block contacting the third spacer block so that a horizontal surface of the first spacer block determines a vertical position of the first and second gauge pins while the pair of vise jaws clamp the article holding fixture between the second and third gauge pills, thereby satisfying requirements of orienting the article holding fixture at a desired angle for machining an article secured to the upper article securing section of the article holding fixture.

2. An article machining apparatus as recited in claim 1 wherein the desired angle is in a range of 0 to 45 degrees.

3. An article machining apparatus as recited in claim 1 wherein the attached group of gauge pins includes the first and second gauge pins of equal diameter and the third gauge pin having a different diameter.

4. An article machining apparatus as recited in claim 1 wherein the attached group of gauge pins includes the first and second gauge pins being 0.375 inches in diameter and the third gauge pin has a 0.500-inch diameter.

5. An article machining apparatus as recited in claim 1 wherein the article holding fixture comprising the upper section, bridge and lower section are formed as a casting with a group of machined surfaces to locate and secure the first, second and third gauge pins to a respective machine surface and to further secure and locate an article to be machined on an article receiving surface located on the upper article securing section.

6. An article machining apparatus adapted for use with a machine vise having a pair of vice jaws with hardened article engagement surface article engagement surfaces, the apparatus comprising:
an article holding fixture having a first, second and third gauge pin attached thereto and a set of at least two spacer blocks; and
a mathematical program derived from a MSN Excel™ program suited for manual entry of a collection of data into a set of formulas in order to no calculate a set of dimensions and components for a predetermined set-up angle for machining an article secured to an article holding fixture.

7. An article machining apparatus as recited in claim 6 wherein at least the first gauge pin has a diameter that is determined from entering the collection of data into the mathematical program and the at least two spacer blocks have dimensions derived from entering the collection of data as a result of processing the data in order to satisfy a condition designed to meet the predetermined angular position of the article holding fixture.

8. An article machining apparatus according to claim 6 wherein the set of formulas includes:
a. x₁=r1; X₂=(H−r₁−r₂) sin θ; x3=y₂ sin θ; x3=y₂ sinθ; x₄=(W−d₃−y₂) cos θ;
x₅=r₃ (1−tan θ) cos θ; x₆=r₃;
b. y₁=r₂ (1-cos θ); y₂=(W−d₃−r₂) sin θ; y₃=r₃/cos θ; y₄=r₃(1−tan θ) sin θ; y₅=r3.

9. An article machining apparatus as recited in claim 8 wherein the dimensions x₁, x₂, x₃, x₄, x₅, x₆, y₁, y₂, y₃, y₄, and y₅ resulting from data entry for the formulas (a.) and (b) are derived from entering each corresponding component of each formula of the set of formulas in the MSN Excel program.

10. An article machining apparatus adapted for use with a machine vise having a pair of vice jaws with hardened article engagement surface article engagement surfaces, the apparatus comprising:
an article holding fixture having an upper article securing section connected to a bridge at an upper end and a foot section connected to the bridge at a lower end, the foot section having an attached group of gauge pins arranged in a pattern wherein a first gauge pin contacts a first spacer block located between the vice jaws on the floor surface of the machine vise, while a second gauge pin contacts a first expandable vice jaw, and a third gauge pin contacts a vertical surface of a second vice jaw and a top surface of a third spacer block while a fourth gauge pin contacts a vertical surface of the first spacer block and a vertical surface of a second spacer block of a collection of spacer blocks when the first and second vice jaws are clamped together according to a predetermined angular position of the article holding fixture thereby positioning the article holding fixture at a predetermined angle; and
a reference table for selecting a predetermined angular position of the article holding fixture as a result of entering a set of fixed values representing the diameter of the first, second and third gauge pins into a mathematical program for calculating a dimension of the spacer block for positioning the article holding fixture within the machine vice jaws.

11. A process for setting up an article holding fixture for machining an article secured to the fixture while the fixture is clamped within a machine vise, the process comprising:
a. determining a number of fixed dimensional values of a set of gauge pins and a desired set-up angle from a table representing a set-up angle and a cross reference to the fixed dimensional values;
b. entering the fixed dimensional values and desired angle into a MSN Excel™ program to provide a set of fixed dimensional values of a gauge pin and a complementary set of spacer blocks according to a set of predetermined formulas representing a number of specific components of the set-up angle for positioning the article holding fixture;
c. installing the number of specific components inside of the machine vise within a clamping area of the vise according to a computed set of dimensions determined by the MSN Excel program; and
d. clamping a pair of expandable vise jaws associated with the vise so as to locate and secure the number of specific components for locating the article holding fixture.

12- An article machining apparatus adapted for use with a machine vise having a pair of vice jaws with hardened article engagement surface article engagement surfaces, the apparatus comprising:
an article holding fixture having an upper article securing section connected to a bridge at an upper end and a foot section connected to the bridge at a lower end, the foot section having an attached group of gauge pins arranged in a pattern wherein a first gauge pin contacts a first spacer block located between the vice jaws on the floor surface of the machine vise, while a second gauge pin contacts a first expandable vice jaw, and a third gauge pin contacts a horizontal surface of at a third spacer block of a stack of spacer blocks and a vertical surface of a second vice jaw while a fourth gauge pin contacts a vertical surface of the first spacer block and a vertical surface of a second spacer block when the first and second vice jaws are clamped together, according to a predetermined angular position of the article holding fixture thereby positioning the article holding fixture at a predetermined angle; and
a reference table for selecting a predetermined angular position of the article holding fixture as a result of entering a set of fixed values representing the diameter of the first, second and third gauge pins into a mathematical program for calculating a dimension of the spacer block for positioning the article holding fixture within the machine vice jaws.

13- An article machining apparatus as recited in claim 12 wherein the pretermined angle is in a range of 0 to 45 degrees.

14- An article machining apparatus adapted for use with a machine vise having a pair of vice jaws with hardened article engagement surface article engagement surfaces, the apparatus comprising:
an article holding fixture having an upper article securing section oriented at substantially 45 degrees with respect to ground, the securing section connected to a bridge at an upper end and a foot section connected to the bridge at a lower end, the foot section having an attached group of gauge pins arranged in a pattern wherein a first gauge pin contacts a first spacer block located between the vice jaws on the floor surface of the machine vise, while a second gauge pin contacts a first expandable vice jaw, and a third gauge pin contacts a horizontal surface of at a third spacer block of a group of spacer blocks, and a vertical surface of a second vice jaw while a fourth gauge pin contacts a vertical surface of the first spacer block and a vertical surface of a second spacer block when the first and second vice jaws are clamped together, according to a predetermined angular position of the article holding fixture thereby positioning the article holding fixture at a predetermined angle; and
a reference table for selecting a predetermined angular position of the article holding fixture as a result of entering a set of fixed values representing the diameter of the first, second and third gauge pins into a mathematical program for calculating a dimension of the spacer block for positioning the article holding fixture within the machine vice jaws.

15- An article machining apparatus as recited in claim 14 wherein the pretermined angle is in a range of 45 to 90 degrees.
